(19) United States
(12) Patent Application Publication
(10) Pub. No.: US 2007/0169054 A1
(43) Pub. Date: Jul. 19, 2007

(54) Process of automatically translating a high level programming language into an extended activity diagram

(75) Inventors: Fu-Chiung Cheng, Taipei City (TW); Kuan-Yu Yan, Taipei City (TW); Jian-Yi Chen, Taipei City (TW); Shu-Ming Chang, Taipei City (TW); Ping-Yun Wang, Taipei City (TW); Li-Kai Chang, Taipei City (TW); Chin-Tai Chou, Taipei City (TW); Ming-Shiou Chiang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/471,485

(22) Filed: Jun. 21, 2006

(30) Foreign Application Priority Data
Dec. 30, 2005 (TW) 094147586

(51) Int. Cl. G06F 9/45

(52) U.S. Cl. 717/156

(57) ABSTRACT

A process of automatically translating a high level programming language into an extended activity diagram (EAD), which can translate source codes coded by the high level programming language into a corresponding activity diagram (AD) before the high level language is translated into a hardware description language (HDL). The process adds a new translation rule in a compiler and modifies the AD specification of a unified modeling language (UML) to accordingly translate the source codes into the AD and present the programming logic and executing flow of the source codes in a visualization form. In addition, the process can translate the high level programming language into a unified format for representation, and the AD can benefit simulation and requirement in a following HDL translation.

### BACKGROUND OF THE INVENTION

1. Field of the Invention

The invention relates to a process of automatically translating high level programming language into an extended activity diagram, and more particularly, to a process of translating source codes coded by a high level programming language into a corresponding activity diagram and presenting programming logic and executing flow of the source codes in a visualization form.

2. Description of Related Art

Typically hardware description languages (HDL) such as VHDL are not suitable directly for describing programming logic and executing flow of a high level programming language. Accordingly, on a hardware description design, the hardware description conditions designed cannot be corresponded directly to the flows designed by the high level language, which leads to a trouble on design. In addition, the typically high level languages cannot be translated directly into an HDL such as VHDL, which is inconvenient on design. Further, the various high level languages, such as Java, C and C++, have different features that cannot be unified into a complete executing flow even the functions of the programs designed by the high level languages are the same.

Therefore, it is desirable to provide an improved process to mitigate and/or obviate the aforementioned problems.

### SUMMARY OF THE INVENTION

The object of the invention is to provide a process of automatically translating a high level programming language into an activity diagram, which adds a translation rule in a compiler to accordingly translate source codes coded by the high level language into a corresponding activity diagram. The process includes the steps: (A) reading a source code; (B) translating the source code read in step (A) into a corresponding subgraph when the source code is not a statement instruction, and executing step (A); (C) translating a statement into a corresponding subgraph when the source code read in step (A) is the statement instruction and the statement is in front of a condition expression in the statement instruction; (D) generating a select node; (E) generating left and right curve points respectively linked to the select node; (F) translating a statement, which is not in front of the condition expression in the statement instruction, into a corresponding subgraph; (G) generating a merge node to merge the subgraphs; (H) linking up the subgraph generated in step (F) with the right curve point; (I) linking up the subgraph generated in step (F) with the merge node; and (J) determining if an instruction is not translated into a corresponding subgraph; if yes, executing step (A); and if not, completing and outputting the corresponding activity diagram. Accordingly, the invention modifies the activity diagram of UML to thus present the programming logic and executing flow of the source codes of the high level language in a visualization form and benefit a following simulation and requirement for a HDL translation.

In the process of automatically translating a high level programming language into an activity diagram according to the invention, the high level language can be Java, C or C++ language.

In the process of automatically translating a high level programming language into an activity diagram according to the invention, the activity diagram is an extended activity diagram defined by a UML language and indicates a flow control graph.

In the process of automatically translating a high level programming language into an activity diagram according to the invention, the activity diagram contains the nodes of start, end, curve point, micro-operation, fork, join, select and merge.

In the process of automatically translating a high level programming language into an activity diagram according to the invention, the statement instruction includes the instructions of for, while, do, if and switch.

Other objects, advantages, and novel features of the invention will become more apparent from the following detailed description when taken in conjunction with the accompanying drawings.

### BRIEF DESCRIPTION OF THE DRAWINGS

FIG. 1 is an activity diagram defined in a UML language;

FIG. 2 is an extended activity diagram defined in an embodiment of the invention;

FIG. 3 is a flowchart of an implementation of translating Java source codes into an EAD according to the invention;

FIG. 4a is a flowchart of an implementation of translating a statement “for” into an EAD according to the invention;

FIG. 4b is a flowchart of an implementation of translating a statement “while” into an EAD according to the invention;

FIG. 4c is a flowchart of an implementation of translating a statement “do” into an EAD according to the invention;

FIG. 4d is a flowchart of an implementation of translating a statement “if” into an EAD according to the invention;

FIG. 4e is a flowchart of an implementation of translating a statement “switch” into an EAD according to the invention;

FIG. 5 is a flowchart of a process of automatically translating a high level programming language into an activity diagram according to the invention;

FIG. 6a is a graph of a Java program according to the invention; and

FIG. 6b is a graph of an EAD corresponding to the Java program of FIG. 6a according to the invention.

### DETAILED DESCRIPTION OF THE PREFERRED EMBODIMENT

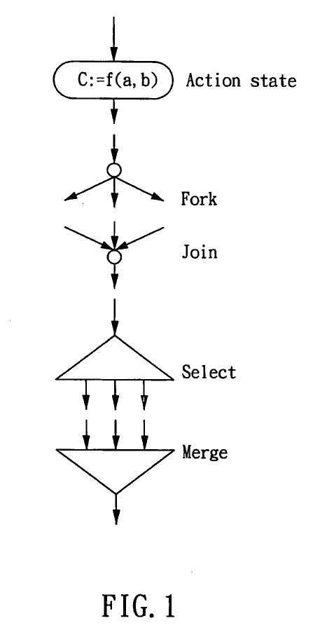

Since the prior process cannot translate a high level programming language into a hardware description language (HDL) directly, the high level programming language, such as Java, C, C++ and so on, is first translated into a temporal format called activity diagram (AD) when a user desires to translate the high level programming language into the HDL. The AD is a flow description graph, as shown in FIG. 1, defined in a unified modeling language and including five elements: action state, fork, join, select and merge. In this embodiment, some elements are modified in order to reserve the information required for certain programs, and the modified activity diagram is referred to as an extended activity diagram, or an EAD for short.

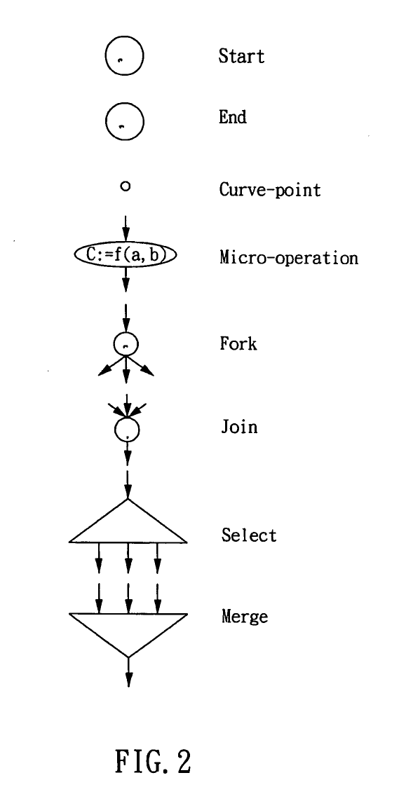

Referring to FIG. 2, the EAD is a corresponding flow control graph translated from the source codes of a high level programming language, which consists of nodes that can be divided into multiple subgraphs with different node combinations, each subgraph having start, operation and end parts. In this embodiment, the nodes are defined as follows.

1. A start node indicates the start of a subgraph.

2. An end node indicates the end of a subgraph.

3. A curve point node indicates two directional edges for providing a convenience in a translation process, which have no practical affection on an operation.

4. A micro-operation node indicates a statement or expression processing.

5. A fork node indicates a parallel operation.

6. A join node indicates that an output signal is sent only when all micro-operations are arrived.

7. A select node indicates to select an appropriate output signal after decoding.

8. A merge node indicates to merge all input signals into an output signal to output.

Each node is regarded as an object in which two types of data are recorded to indicate an in-node connected to the node and an out-node connecting from the node to another node, and the node type is changed with the syntax. A corresponding subgraph is generated with each syntax segment analysis, and the in-nodes and out-nodes of the subgraph are recorded for other subgraphs to further link and use. Accordingly, a corresponding subgraph can be generated by such a linking for each syntax segment, and linking all subgraphs can achieve the purpose of translating source codes into a corresponding activity diagram and presenting the programming logic and executing flow of the source codes in a visualization form.

As cited, a complete EAD consists of plural subgraphs. The first subgraph records an information of class referred to as a class subgraph, and each other subgraph corresponds to a method. Each part of a subgraph consists of different nodes. The class subgraph is started with a start node referred to as a class start node, and the class start node contains various labels. The notations used in a subgraph are described as follows.
C=className, modifier:

where C indicates a class, and className, modifier respectively indicate name, modifier of the class. The modifier is expressed by a number, including:
0x0001: PUBLIC;
0x0010: FINAL;
0x0400: ABSTRACT;
0x0800: STRICT.
G=type, size, variable Name:

where G indicates a global variable, and type, size, variable Name respectively indicate type, size, and name of the global variable. The type and the size are defined the same as in Java.
M=method Name, modifier:

where M indicates a method, and method Name, modifier respectively indicate name, modifier of the method. The modifier is expressed by a number, including:

| | |
|---|---|
| 0x0001: PUBLIC; | 0x0002: PRIVATE; |
| 0x0004: PROTECTED; | 0x0008: STATIC; |
| 0x0010: FINAL; | 0x0020: SYNCHRONIZED; |
| 0x0100: NATIVE; | 0x0400: ABSTRACT; |
| 0x0800: STRICT. | |

The operation part of the class subgraph can be divided into left and right divisions: left referred to as a class variable division and right referred to as an instance variable division. A directional edge links between the start part and the class and instance variable divisions respectively, i.e., an arrow is directed from the start part to the class variable division and the instance variable division respectively labeled “class” and “instance”, which are referred as an edge label.

The class variable division and the instance variable division contain all micro-operation nodes except the first node to be the start node, and two nodes is linked by an edge in an arrow direction from up to down. The class variable division has a content “m=sinit, 0” of the start node, and the instant variable division has a content “m=init, 0”. In the two divisions, the content of a micro-operation node is an initial value declaration. The end parts of the two divisions are represented by an end node respectively with a content “return VOID sinit” and “return VOID init”.

The start part of a method subgraph is indicated by a start node, which contains plural labels described as follows.

M=method Name, modifier: where M indicates a method, and method Name, modifier respectively indicate name, modifier of the method. The modifier is expressed by a number, including:

| | |
|---|---|
| 0x0001: PUBLIC; | 0x0002: PRIVATE; |
| 0x0004: PROTECTED; | 0x0008: STATIC; |
| 0x0010: FINAL; | 0x0020: SYNCHRONIZED; |
| 0x0100: NATIVE; | 0x0400: ABSTRACT; |
| 0x0800: STRICT. | |

R=type, size, ret method Name: where R indicates an information of a return of the method, and type, size, method Name respectively indicate type, size, name of the return. The type and the size are defined the same as in Java.
P=type, size, variable Name: where P indicates a pass-in parameter, and type, size, variable Name respectively indicate type, size, variable name of the pass-in parameter. The type and the size are defmed the same as in Java.
L=type, size, variable Name: where L indicates a local variable, and type, size, variable Name respectively indicate type, size, name of the local variable. The type and the size are defined the same as in Java.

As cited, the graph specification used in all subgraphs of an extended activity diagram is described.

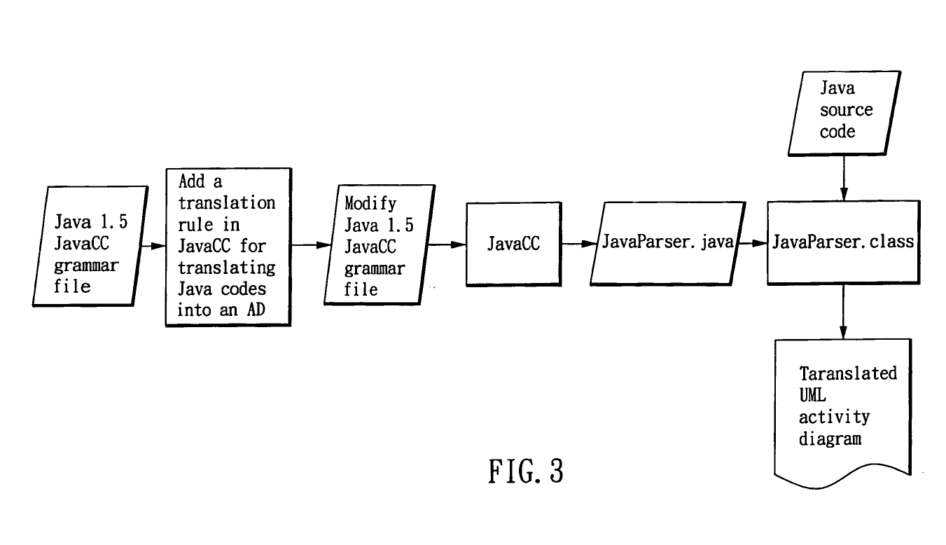

FIG. 3 is a flowchart of an implementation of translating Java source codes into an EAD according to the invention. In FIG. 3, an example is given in a Java language to translate a Java program into an EAD. As shown in FIG. 3, upon the Java standard syntax specification (using Java development Kit (JDK) 1.5) defined by Java Complier Complier (briefly, JavaCC hereinafter), a Java segment is added in a JavaCC grammar file to generate a modified Java syntax file (with an extended filename “jj”). Thus, the JavaCC can generate a Java parser class and other classes required by the Java parser, according to the Java program with the added segment. The Java parser class can provide the function of translating Java source codes into a corresponding EAD. In this case, the Java parser class is integrated into a computer aided design (CAD) software, such that the CAD software is equipped with the translating function. Subsequently, the complete source codes of a Java program are sent to the Java parser. The Java parser can match different tokens in the Java program with new EAD instructions generated in the modified syntax file, and accordingly executes a translation to obtain a desired EAD.

Due to various types of tokens in the Java program, only representative statement instructions, condition expressions and statements, and their translation flows and rules are described. In this case, the statement instruction includes the types of for, while, do, if and switch, and associated translation flows and rules are described respectively as follows.

### EXAMPLE 1

Translation of For Statement

The syntax is represented by for ([ForInit( )]; [Expression( )]; [ForUpdate( )]) Statement( ).

A translation description is given in the following example.

| | |
|---|---|
| for (int i =1 ;i <= cnt ; i++) | { |

sum+=i;

}

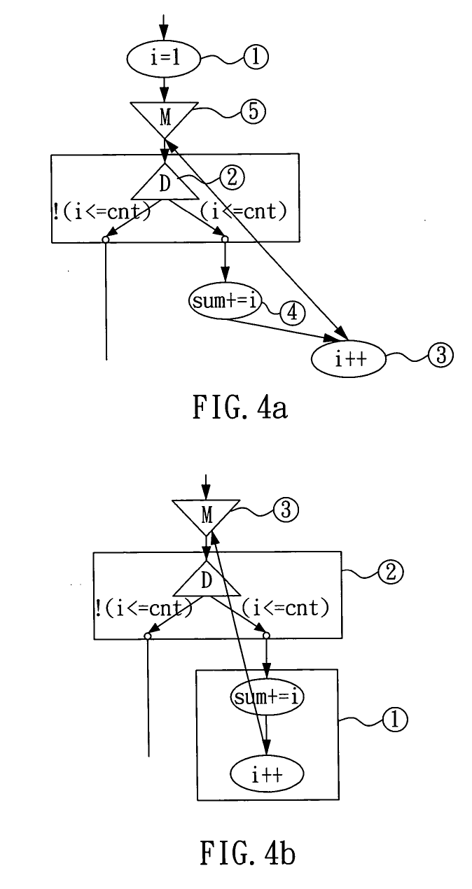

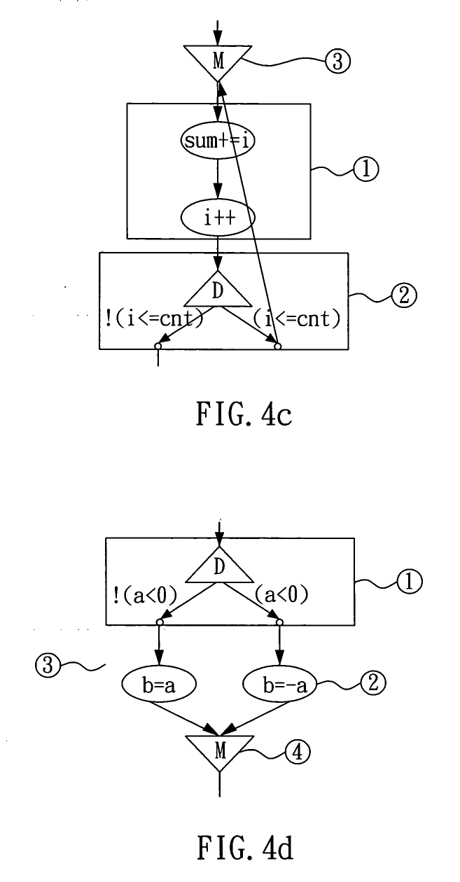

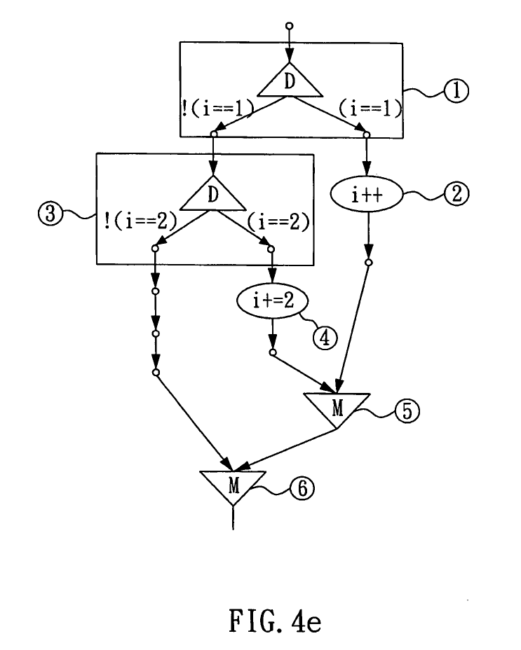

Referring to FIG. 4a, the translation is processed with the following steps.

Step 1 analyzes “for” and “(”;

Step 2 analyzes the content of For Init( ) to thereby draw a subgraph that is an oval node with a content of i=1 (notation \hat{1}), and forms the in-node and out-node edges of the subgraph;

Step 3 analyzes “;”;

Step 4 analyzes the content of Expression( ) to thereby execute the added Java program, e.g., “processConditionExpression( )”, in order to generate a decoder (D) node and two lower edges thereof, on which edge labels are generated, and further draws a complete subgraph (a set of nodes), as shown in (notation \hat{2}, and sets in-node and out-nodes of the complete subgraph;

Step 5 analyzes “;”;

Step 6 analyzes the content of ForUpdate to thereby draw a subgraph that is an oval node with a content of i++ (notation \hat{3}) and obtain an out-node of the subgraph;

Step 7 analyzes “)”;

Step 8 analyzes the content of Statement( ) to thereby draw a subgraph that is an oval node with a content of sum+=i, as shown in notation \hat{4};

Step 9 links the out-node of the \hat{2} subgraph representative of the Expression( ) to the \hat{3} in-node;

Step 10 generates a merge (M) node as shown in notation \hat{5};

Step 11 links the out-node of the content of Statement( ) to an in-node of the M node;

Step 12 forms the in-node and out-node edges of the M node.

Accordingly, an implementation of translating the “for” statement in the Java source codes into the EAD is described.

### EXAMPLE 2

Translation of While Statement

The syntax is represented by while (Expression( )) Statement( ).

A translation description is given in the following example.

while (i <= cnt) {

sum+=i;
i++;

}

Referring to FIG. 4b, the translation is processed with the following steps.

Step 1 analyzes “while” and “(”;

Step 2 analyzes the content of Expression( ) to thereby executes the added Java program “processConditionExpression( )” in order to generate a decode (D) node and two lower edges thereof, on which edge labels are generated, and further draws a complete subgraph (a set of nodes), as shown in notation \hat{2}, and sets an in-node and out-node of the complete subgraph;

Step 3 analyzes “)”;

Step 4 analyzes the content of Statement( ) to thereby generate a subgraph, as shown in notation \hat{1} and obtain an in-node and out-node of the \hat{1} subgraph;

Step 5 links the out-node of the notation \hat{2} to the in-node of the notation \hat{1};

Step 6 generates a merge (M) node, as shown in notation \hat{3};

Step 7 links the out-node of the notation \hat{1} to the M node;

Step 8 forms the in-node and out-node edges of the M node.

Accordingly, an implementation of translating the “while” statement in the Java source codes into the EAD is described.

### EXAMPLE 3

Translation of Do Statement

The syntax is represented by do Statement( ) while (Expression( )).

A translation description is given in the following example.

do {

| | |
|---|---|
| sum+=i; | i++; |

} while (i <=cnt);

Referring to FIG. 4c, the translation is processed with the following steps.

Step 1 analyzes “do”;

Step 2 analyzes the content of Statement( ) to thereby generate a subgraph, as shown in notation \hat{1}, and obtain the out-node of the subgraph;

Step 3 analyzes “while” and “(”;

Step 4 analyzes the content of Expression( ) to thereby executes the added Java program “processConditionExpression( )” in order to generate a decode (D) node and two lower edges thereof, on which edge labels are generated, and further draws a complete subgraph (a set of nodes), as shown in notation \hat{2}, and sets an in-node and out-node of the complete subgraph;

Step 5 analyzes “)” and “;”;

Step 6 links the out-node of the notation \hat{2} to the in-node of the notation \hat{1});

Step 7 generates a merge (M) node, as shown in notation \hat{3};

Step 8 links the out-node of the notation \hat{2} to the M node;

Step 9 forms the in-node and out-node edges of the M node.

Accordingly, an implementation of translating the “do” statement in the Java source codes into the EAD is described.

### EXAMPLE 4

Translation of If Statement

The syntax is represented by if (Expression( )) Statement( )[else Statement( )].

A translation description is given in the following example.

if (a < 0) {

b = −a;

} else {

b = a;

}

Referring to FIG. 4d, the translation is processed with the following steps.

Step 1 analyzes “if” and “(”;

Step 2 analyzes the content of Expression( ) to thereby execute the added Java program “processConditionExpression( )” in order to generate a decoder (D) node and two lower edges thereof, on which edge labels are generated, and further draws a complete subgraph (a set of nodes), as shown in notation \hat{1}), and sets in-node and out-nodes of the complete subgraph;

Step 3 analyzes “)”;

Step 4 analyzes the content of Statement( ) to thereby draw a subgraph that is an oval node with a content of b=−a, as shown in notation \hat{2}, and obtain the in-node of the \hat{2} subgraph;

Step 5 analyzes “else”;

Step 6 analyzes the content of else statement( ) to thereby draw a subgraph that is an oval node with a content of b=a, as shown in notation \hat{3}, and obtain the out-node of the subgraph;

Step 7 links the out-node 1 (right) of the \hat{1} subgraph to the in-node of the \hat{2} subgraph;

Step 8 links the out-node 0 (left) of the \hat{1} subgraph to the in-node of the \hat{3} subgraph;

Step 9 generates a merge (M) node as shown in notation \hat{4};

Step 10 links the out-nodes of the \hat{2} and \hat{3} subgraphs to the M node.

Accordingly, an implementation of translating the “if” statement in the Java source codes into the EAD is described.

### EXAMPLE 5

Translation of Switch Statement

The syntax is represented by

switch ( Expression( ) ) {

( SwitchLabel( ) ( BlockStatement( ) )* )*}

SwitchLabel( ){ case Expression( ) : default : }

if (Expression( )) Statement( )[ else Statement( ) ].

A translation description is given in the following example.

switch (i) {

case 1:

i++;
break;

case 2:

i += 2;
break;

default:

System.out.println(“That's not a valid no!”);
break;

}

Referring to FIG. 4e, the translation is processed with the following steps.

Step 1 analyzes “switch” and “(”;

Step 2 analyzes the content of Expression( ) and stores the variable i;

Step 3 analyzes “)” and “{”;

Step 4 analyzes the content of a Switch Label( ), and links up “case Expression” with the variable in Expression( ) to thereby obtain a subgraph, as shown in notation \hat{1} in which a decoder (D) node, edges and edge labels are included, and two out-nodes, Out-Node 0 and Out-Node 1 are set;

Step 5 analyzes the content of Block Statement( ) and draws a subgraph that is an oval node with a content of i++, as shown in notation \hat{2}, and set the Out-Node 0 to be the out-node of the subgraph;

Step 6 analyzes the other Switch Label( ) as shown in steps 4 and 5, but for the second Switch Label( ) analysis and more, as shown in notations \hat{3}, \hat{4} and \hat{5}, a determination for generating a merge (M) node is added;

Step 7 generates a merge (M) node to link the other out-nodes as shown in notation \hat{6}.

Accordingly, an implementation of translating the “switch” statement in the Java source codes into the EAD is described.

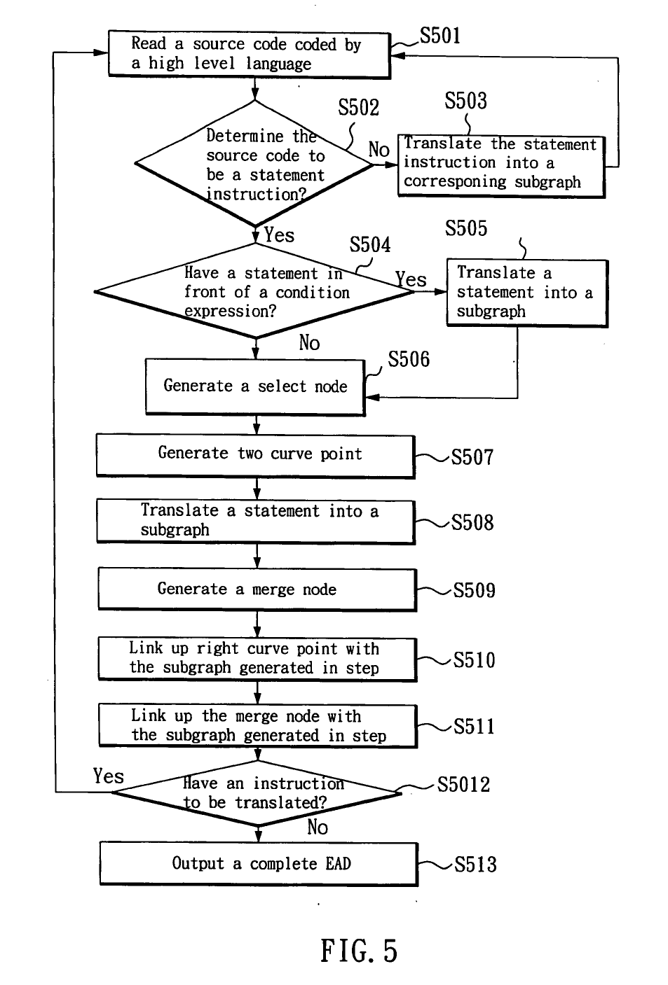

Therefore, FIG. 5 shows a complete translation process. As shown in FIG. 5, for automatically converting source codes into a corresponding activity diagram, first, a source code of a high level programming language is read (step S501). Next, a type of the source code is determined to be a statement instruction or not. In this case, the statement instruction includes the instructions of for, while, do, if and switch. When the source code is not a statement instruction, i.e., the source code is a non-statement instruction not including the instructions of for, while, do if and switch, the non-statement instruction is translated directly into a corresponding subgraph (step S503), and a next source code is read (step S501).

When the source code is determined to be a statement instruction in step S502, it is further determined if a statement is in front of a condition expression in the statement instruction (step S504); if yes, the statement is translated into a corresponding subgraph (step S505), and subsequently a select node is generated (step S506).

When there is no statement in front of a condition expression in the statement instruction, the select node is generated directly (step S506). Next, left and right curve points are generated (step S507) and respectively linked to the select node. Next, a statement, which is not in front of the condition expression in the statement instruction, is translated into a corresponding subgraph (step S508). Next, a merge node is generated (step S509) to merge the subgraphs. Next, the subgraph generated in step F is respectively linked up with the right curve point (step S510) and the merge node (step S511). At last, it is determined if an instruction is to be translated into a corresponding subgraph (step S512); if yes, step (A) is executed; and if not, a complete extended activity diagram (EAD) is output (step S513).

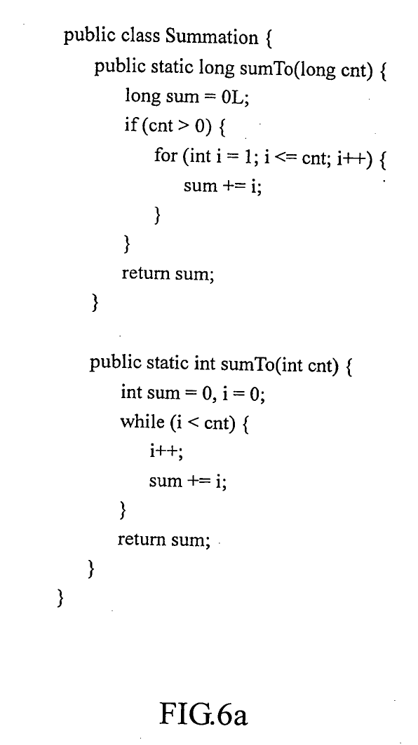

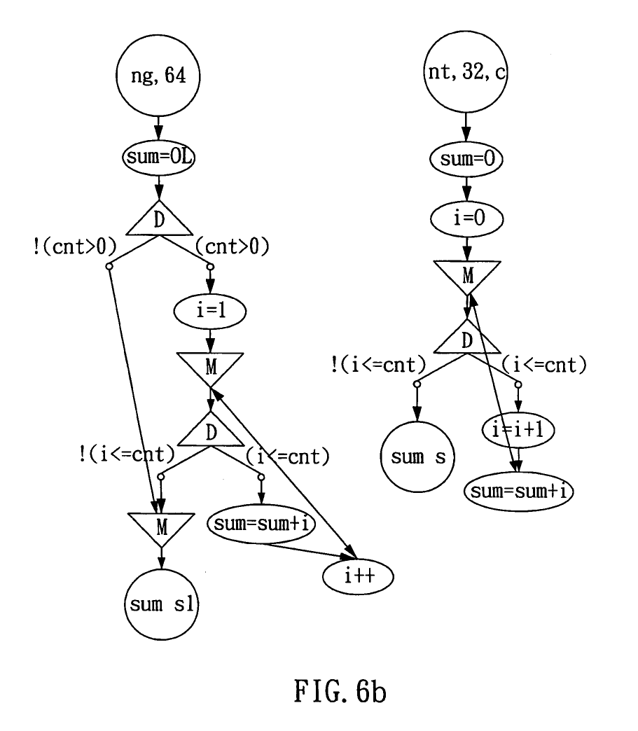

Accordingly, a complete Java program can be translated into a corresponding EAD, and the programming logic and executing flow of the source codes of the high level language is presented in a visualization form. FIG. 6a is a graph of an accumulation program coded with if and while statements of the Java language, which can be translated into a corresponding EAD shown in FIG. 6b, according to the translation flow and rule of the invention. In addition, programs having a same function and coded by different high-level languages can be translated into the respective EADs. An EAD is generated different with different Java grammars.

As cited, the invention adds a translation rule in a compiler to thereby translate various source codes in different high level programming languages (such as Java, C, C++ and the like) into the respective EADs automatically to thus present the programming logic and executing flow of the source codes in a visualization form. Accordingly, the various high level programming languages are integrated into a unified format for representation, which benefits a following simulation and requirement for a HDL translation.

Although the present invention has been explained in relation to its preferred embodiment, it is to be understood that many other possible modifications and variations can be made without departing from the spirit and scope of the invention as hereinafter claimed.

What is claimed is:

1. A process of automatically translating a high level programming language into an activity diagram, which adds a translation rule in a compiler to accordingly translate source codes coded by the high level language into a corresponding activity diagram, the process comprising the steps:
(A) reading a source code;
(B) translating the source code read in step (A) into a corresponding subgraph when the source code is not a statement instruction, and executing step (A);
(C) translating a statement into a corresponding subgraph when the source code read in step (A) is the statement instruction and the statement is in front of a condition expression in the statement instruction;
(D) generating a select node;
(E) generating left and right curve points respectively linked to the select node;
(F) translating a statement, which is not in front of the condition expression in the statement instruction, into a corresponding subgraph;
(G) generating a merge node to merge the subgraphs;
(H) linking up the subgraph generated in step (F) with the right curve point;
(I) linking up the subgraph generated in step (F) with the merge node; and
(J) determining if an instruction is to be translated into a corresponding subgraph; if yes, executing step (A); and if not, completing and outputting the corresponding activity diagram.

2. The process as claimed in claim 1, wherein the high level programming language is selected from Java, C and C++.

3. The process as claimed in claim 1, wherein the activity diagram is an extended activity diagram defined in a unified modeling language (UML), which represents a flow control graph.

4. The process as claimed in claim 1, wherein the activity diagram comprises start node, end node, curve point node, micro-operation node, fork node, join node, select node and merge node.

5. The process as claimed in claim 1, wherein the compiler uses Java Compiler Compiler (JavaCC) when the source codes are Java codes, and the JavaCC uses Java Development Kit 1.5 (JDK 1.5) to add the translation rule.

6. The process as claimed in claim 1, wherein the statement instruction comprises five instructions, for, while, do, if and switch.
